(19) United States
(12) Patent Application Publication
(10) Pub. No.: US 2008/0001540 A1
(43) Pub. Date: Jan. 3, 2008

(54) Electrodeless lamp for phototherapy

(75) Inventors: Robert Martin, Nicholasville, KY (US); Arunava Dutta, Winchester, MA (US); Aline Tetreault, Kingsey Falls (CA)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/823,939

(22) Filed: Jun. 30, 2007

Related U.S. Application Data
(60) Provisional application No. 60/818,216, filed on Jun. 30, 2006.

(51) Int. Cl. H01J 40/16

(52) U.S. Cl. 313/523

(57) ABSTRACT

A photo-therapeutic, electrodeless lamp (10) comprising a closed-loop envelope (12) containing an arc generating and sustaining medium that includes mercury. A phosphor coating (14) is provided on the interior surface of the envelope (12). The phosphor coating is capable of generating a first radiation in response to excitation from 254 nm radiation and provides the first radiation having an energy output in the region of 335-430 nm. This wavelength region is most efficient for the treatment of morphea or scleroderma. The output radiated energy from the lamp in the 335-430 nm region is ≧20,000 μW/cm². In a preferred embodiment of the invention the phosphor is SrB₄O₇:Eu, which has a spectral response with a peak between 366-368 nm with a bandwidth of about 18 nm.

### CROSS-REFERENCE TO RELATED APPLICATION

This application claims Priority from Provisional Patent Application Ser. No. 60/818,216, filed Jun. 30, 2006.

### TECHNICAL FIELD

This invention relates to electrodeless fluorescent lamps and more particularly to such lamps for use in phototherapy.

### BACKGROUND ART

Phototherapy is used in the medical community to treat, among other conditions, various skin disorders. The treatment consists primarily of giving particular medicines to a patient and subsequently activating these medicines by irradiating the patient with specific visible or non-visible (for example, UV) radiation. To produce the desired radiation various light sources have been employed. Important features of these light sources include: radiated power; power bandwidth, power homogeneity; and power depreciation over time (also referred to as maintenance). The various light sources previously employed generally comprise elongated fluorescent tubing which, while workable, present obvious handling problems.

### DISCLOSURE OF INVENTION

It is, therefore, an object of the invention to obviate the disadvantages of the prior art.

It is another object of the invention alleviate prior shortcomings in the treatment of diseases.

These objects are accomplished, in one aspect of the invention, by the provision of a photo-therapeutic, electrodeless lamp comprising: a closed-loop envelope containing an arc generating and sustaining medium; a phosphor coating on the interior of the envelope capable of generating a first radiation in response to excitation from 254 nm radiation, the first radiation having an energy output in the region of 335-430 nm of ≧20,000 μW/cm²; a reflector formed on a portion of the envelope leaving a window for the emission of the first radiation; and means formed with the lamp for supplying RF excitation to generate the 254 nm radiation.

The electrodeless lamp has a long life expectancy and can meet the desired power requirements.

### BRIEF DESCRIPTION OF THE DRAWINGS

FIG. 1 is a side, elevational view of an electrodeless lamp according to an aspect of the invention;

FIG. 2 is a plan view thereof; and

FIG. 3 is a graph of the spectral power distribution of the lamp with a particular phosphor.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

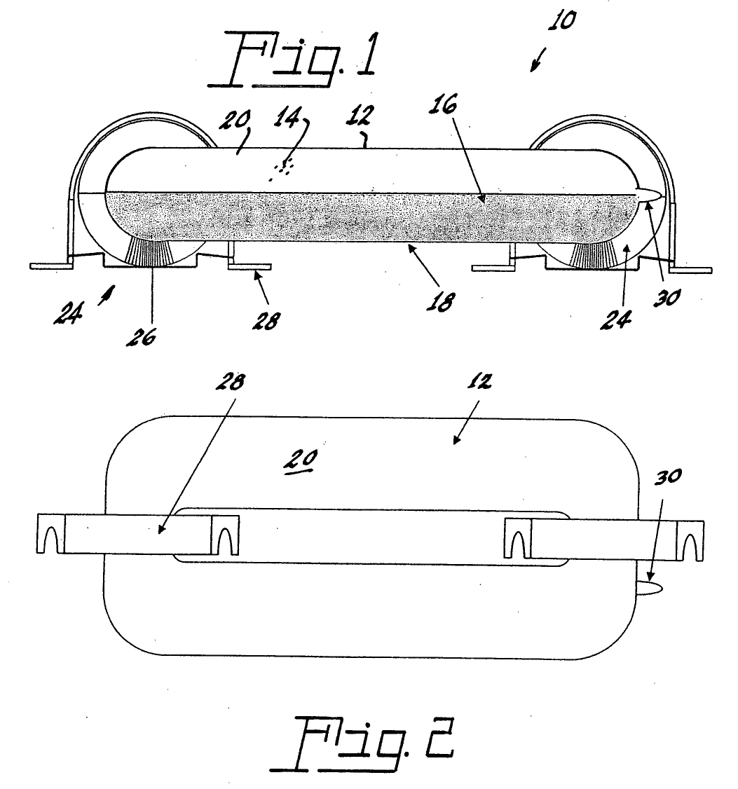

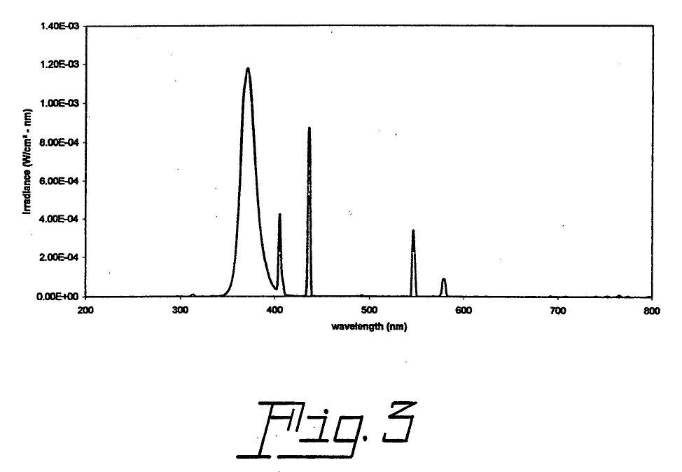

Referring now to the drawings with greater particularity, there is shown in FIG. 1 a photo-therapeutic, electrodeless lamp 10 comprising a closed-loop envelope 12 containing an arc generating and sustaining medium that includes mercury. A phosphor coating 14 is provided on the interior surface of the envelope 12. The phosphor coating is capable of generating a first radiation in response to excitation from 254 nm radiation and provides the first radiation having an energy output in the region of 335-430 nm. This wavelength region is most efficient for the treatment of morphea or scleroderma. To be truly effective, it is a requirement that the output radiated energy from the lamp in the 335-430 nm region is ≧20,000 μW/cm². The radiated power is an important consideration to reduce the amount of time that a patient needs to be exposed to the source. In a preferred embodiment of the invention the phosphor is SrB₄O₇:Eu, which has a spectral response with a peak between 366-368 nm with a bandwidth of about 18 nm. Targeting the more efficient wavelengths, 365-375 nm, as does the above-cited phosphor, renders more efficient photoactivation of the medicine and enables the use of a lower radiated power to achieve the same results, reducing discomfort to the patient. In addition to the preferred material cited above, other phosphors, such, for example, as (BaSrMg)₃Si₂O₇:Pb, which peaks at about 372 nm with a bandwidth of about 69 nm, or YPO₄:Ce can be used. The latter has its peak emission at 356-358 nm, which, while lower than the preferred range of 365-375 nm, is close enough to be viable in some instances. Mixtures of the above phosphors also can be used to provide the desired radiation. The phosphor that generated the results shown in FIG. 3 is SrB₄O₇:Eu. The total flux in the 335-430 nm region is about 25,300 μW/cm².

The flux was measured at a distance of 10 cm from the middle of the outer surface of the lamp using a commercial spectral radiometer such as the OL754.

To produce the high output UVA flux described above, the electrodeless lamp is operated with a lamp voltage between 165-180 V and a lamp current of between 810-850 mA. The lamp wattage is between 135-145 W.

The powder loading of the phosphors can vary between 2 to 5 mg/cm². Depositing a layer of protective material over the phosphor can increase the lumen maintenance of the lamp. Materials such as alumina or yttria are efficacious by absorbing damaging 185 nm radiation, which is also generated from the low-pressure mercury discharge, in addition to the desirable 254 nm radiation. These materials can be deposited by a variety of known methods such as CVD, sol gel, etc.

A reflector 16 is formed on a portion 18 of the envelope 12 leaving a window 20 for the emission of the visible radiation. The reflector 16 is important to increase the radiated power from the lamp for therapeutic purposes and can be applied to the interior or exterior of the envelope, but the interior is preferred. The reflector layer preferably comprises a powder possessing the appropriate material characteristics so as to reflect the first radiation towards the lamp window 20. The powder loading of the reflector can vary between 5-15 mg/cm² and when the SrB₄O₇:Eu phosphor is used the reflector material is preferably alpha alumina with a powder loading between 7-12 mg/cm². The reflector material has a surface area between 3-10 m²/g. More preferably, the reflector material has a surface area between 5-8 m²/g. The 50% particle size of the reflector material is preferably between 0.2-2 μm.

Conventional means 24 are formed with the lamp 10 for supplying RF excitation to generate the 254 nm radiation and comprise magnetic cores with windings 26. Such means are shown, for example, in U.S. Pat. No. 5,834,905, which is assigned to the assignee of the present invention and whose teachings are herein incorporated by reference. The lamp 10 can conveniently be supported by aluminum fittings 28. An amalgam tip 30 allows for evacuation and filling of the lamp and can provide a repository for the amalgam that is a part of the arc generating and sustaining medium.

In a preferred embodiment of the invention the envelope has dimensions of about 250 mm×137 mm and thus encompasses an area of about 342.5 cm², this area being sufficient to cover an entire side of a patient's face, for example. This ensures homogeneity of the radiated power on the face of the patient. It also enables an operator to position the lamp as close as needed to the patient's face (to increase irradiated power) while still maintaining homogeneity. Such positioning was heretofore very difficult if not impossible with the previously employed, elongated fluorescent lamps.

Therefore, there is herein provided a UVA dispensing lamp that can produce >20,000 μW/cm² in the 335 to 430 nm bandwidth, with a peak intensity in the 365-375 nm region, and deliver the radiated power homogeneously at a close distance across a large region of a patient's body.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A photo-therapeutic, electrodeless lamp comprising:
a closed-loop envelope containing an arc generating and sustaining medium;
a phosphor coating on the interior of said envelope, said phosphor coating being capable of generating a first radiation in response to excitation from 254 nm radiation, said first radiation having an energy output in the region of 335-430 nm of ≧20,000 μW/cm²;
a reflector formed on a portion of said envelope leaving a window for the emission of said first radiation; and
means formed with said lamp for supplying RF excitation to generate said 254 nm radiation.

2. The lamp of claim 1 wherein said envelope encompasses an area of about 342.5 cm².

3. The lamp of claim 1 wherein said phosphor is selected from the group consisting of SrB₄O₇:Eu; (BaSrMg)₃Si₂O₇:Pb; and YPO₄Ce and mixtures thereof.

4. The lamp of claim 3 wherein said first radiation is in the region of 365-375 nm.

5. The lamp of claim 4 wherein said visible radiation is in the region of 366-368 nm and has a bandwidth of 18 nm

6. The lamp of claim 1 wherein said energy output is obtained by operating said lamp between 165-180 V.
